(19) United States
(12) Patent Application Publication
(10) Pub. No.: US 2009/0265228 A1
(43) Pub. Date: Oct. 22, 2009

(54) POINT OF SALE COUPON SYSTEMS AND METHODS

(75) Inventors: Jacob M. Sterling, St. Louis, MO (US); Andrew T. Hurt, Centennial, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 12/104,904

(22) Filed: Apr. 17, 2008

(51) Int. Cl. G06Q 10/00

(52) U.S. Cl. 705/14

(57) ABSTRACT

Systems and methods of offering incentives such as electronic coupons at a point of sale. Transaction information gathered at a point of sale system is received at a host computer. The transaction information relates to a transaction performed by a consumer at a merchant, and includes a consumer account identifier identifying an account from which payment is to be made for the transaction, and includes a merchant identifier identifying the merchant. Using the host computer, it is recognized that the combination of merchant and consumer account identifiers qualifies for an incentive offer. The host computer transmits a description of the incentive offer to be offered to the consumer at the point of sale, and receives an indication that the consumer has accepted the offer. In a database maintained by the host computer, an indication is recorded that the offer is pending for the combination of consumer account and merchant identifiers.

### BACKGROUND OF THE INVENTION

Manufacturers, merchants, and other entities issue millions of paper coupons each year in an effort to capture the business of new customers and to attract repeat business from existing customers. Many coupons go unredeemed. The reasons for unredeemed coupons vary, but may include perceived inconvenience in the redemption process, and that coupons are lost or misplaced, and that many coupons are delivered to consumers with little interest in the products or services to which the coupons apply.

### BRIEF SUMMARY OF THE INVENTION

In one embodiment, a method of providing incentives comprises receiving, at a host computer, transaction information gathered at a point of sale system. The transaction information relates to a transaction performed by a consumer at a merchant. The transaction information includes a consumer account identifier identifying an account from which payment is to be made for the transaction, and also comprises a merchant identifier identifying the merchant. Using the host computer, it is recognized that the combination of the merchant identifier and the consumer account identifier qualifies for an incentive offer. The host computer transmits a description of the incentive offer to be offered to the consumer at the point of sale, and receives an indication that the consumer has accepted the offer at the point of sale for the transaction. In a database maintained by the host computer, an indication is recorded that the offer is pending for the combination of consumer account identifier and merchant identifier. In some embodiments, the incentive is an electronic coupon to be applied to a future transaction conducted with the same combination of consumer account identifier and merchant identifier.

In some embodiments, the transaction is a first transaction and the transaction information is first transaction information, and the method further comprises receiving second transaction information gathered at a point of sale. The second transaction information relates to a second transaction and comprises the consumer account identifier and the merchant identifier. The database is searched based on the combination of the consumer account identifier and the merchant identifier, and it is recognized, based on the search, that the offer is pending for the combination of consumer account identifier and merchant identifier. An indication is transmitted to the point of sale system that the incentive should be applied to the second transaction. In some embodiments, the method further comprises removing from the database the indication that the offer is pending. In some embodiments, the method further comprises leaving in the database the indication that the offer is pending. In some embodiments, the method further comprises as part of the second transaction transmitting the description of the same incentive offer to be offered to the consumer at the point of sale. In some embodiments, the method further comprises as part of the second transaction transmitting the description of a different incentive offer to be offered to the consumer at the point of sale.

In some embodiments, the method further comprises recording a history of incentive offers offered and accepted for the combination of consumer account identifier and merchant identifier. In some embodiments, the method further comprises recognizing, based on the history, that a milestone has been reached, and as part of the second transaction transmitting a description of a milestone incentive offer to be offered to the consumer at the point of sale. In some embodiments, the offer is made by the merchant. In some embodiments, the offer is made by an issuer of the consumer account.

In some embodiments, the transaction is a first transaction and the transaction information is first transaction information, and the method further comprises receiving second transaction information gathered at a point of sale. The second transaction information relates to a second transaction and comprises the consumer account identifier and the merchant identifier. The database is searched based on the combination of the consumer account identifier and the merchant identifier, and it is recognized, based on the search, that the offer is outstanding for the combination of consumer account identifier and merchant identifier. An indication is transmitted to the point of sale system that the incentive offer should be applied to the second transaction, and it is instructed that funds be transferred from the issuer to the merchant reimbursing the merchant for a value lost or foregone by the merchant in applying the incentive offer. In some embodiments, the offer is made jointly by the merchant and an issuer of the consumer account.

In some embodiments, the transaction is a first transaction, the consumer is a first consumer, the consumer account identifier is a first consumer account identifier, the account is a first account, the indication is a first indication, and the transaction information is first transaction information, and the method further comprises receiving second transaction information gathered at the point of sale system. The second transaction information relates to a second transaction performed by a second consumer at the merchant. The second transaction information comprises a second consumer account identifier identifying a second account from which payment is to be made for the second transaction, and also comprises the merchant identifier. It is recognized that the combination of the merchant identifier and the second consumer account identifier qualifies for the incentive offer, and a description is transmitted of the incentive offer to be offered to the second consumer at the point of sale. An indication is received that the second consumer has declined the offer, and the acceptance of the offer by the first consumer and the decline of the offer by the second consumer are recorded in the same or another database.

In another embodiment, a system for providing incentives comprises a host computer comprising a processor and computer-readable storage, the computer-readable storage holding a database and program instructions. The host computer executes the instructions to receive transaction information gathered at a point of sale system. The transaction information relates to a transaction performed by a consumer at a merchant, and comprises a consumer account identifier identifying an account from which payment is to be made for the transaction, and also comprises a merchant identifier identifying the merchant. The host computer also executes the instructions to recognize that the combination of the merchant identifier and the consumer account identifier qualifies for an incentive offer, to transmit a description of the incentive offer to be offered to the consumer at the point of sale, to receive an indication that the consumer has accepted the offer at the point of sale for the transaction, and to record in the database an indication that the offer is pending for the combination of consumer account identifier and merchant identifier.

In some embodiments, the transaction is a first transaction and the transaction information is first transaction information, and the host computer further executes the instructions to receive second transaction information gathered at a point of sale. The second transaction information relates to a second transaction, and comprises the consumer account identifier and the merchant identifier. The host computer further executes the instructions to search the database based on the combination of the consumer account identifier and the merchant identifier, to recognize, based on the search, that the offer is pending for the combination of consumer account identifier and merchant identifier, and to transmit to the point of sale system an indication that the incentive should be applied to the second transaction.

In some embodiments, the host computer further executes the instructions to remove from the database the indication that the offer is pending. In some embodiments, the host computer further executes the instructions to leave in the database the indication that the offer is pending. In some embodiments, the host computer further executes the instructions to, as part of the second transaction, transmit the description of the same incentive offer to be offered to the consumer at the point of sale. In some embodiments, the host computer further executes the instructions to, as part of the second transaction, transmit a description of a different incentive offer to be offered to the consumer at the point of sale. In some embodiments, the host computer further executes the instructions to record a history of incentive offers offered and accepted for the combination of consumer account identifier and merchant identifier.

In some embodiments, the host computer further executes the instructions to recognize, based on the history, that a milestone has been reached, and to, as part of the second transaction, transmit a description of a milestone incentive offer to be offered to the consumer at the point of sale. In some embodiments, the host computer further executes the instructions to instruct that funds be transferred from the issuer to the merchant reimbursing the merchant for a value lost or foregone by the merchant in applying the incentive offer.

In another embodiment, a method of providing incentives comprises receiving, at a host computer, transaction information gathered at a point of sale system. The transaction information relates to a transaction performed by a consumer at a merchant, and comprises a consumer account identifier identifying an account from which payment is to be made for the transaction, and also comprises a merchant identifier identifying the merchant, and also comprises at least one product identifier identifying a product purchased in the transaction. The host computer recognizes that the combination of the merchant identifier and the consumer account identifier and the product identifier qualifies for an incentive offer, and transmits a description of the incentive offer to be offered to the consumer at the point of sale. The host computer receives an indication that the consumer has accepted the offer at the point of sale for the transaction, and records in a database maintained by the host computer an indication that the offer is pending for the combination of consumer account identifier and merchant identifier and product identifier.

In some embodiments, the transaction is a first transaction and the transaction information is first transaction information, and the method further comprises receiving second transaction information gathered at a point of sale. The second transaction information relates to a second transaction, and comprises the consumer account identifier and the merchant identifier and the product identifier. The database is searched based on the combination of the consumer account identifier and the merchant identifier and the product identifier, and it is recognized, based on the search, that the offer is pending for the combination of consumer account identifier and merchant identifier and the product identifier. An indication is transmitted to the point of sale system that the incentive should be applied to the second transaction.

In another embodiment, a method of providing incentives comprises receiving, at a host computer, transaction information gathered at a point of sale system. The transaction information relates to a transaction performed by a consumer at a merchant, and comprises a consumer account identifier identifying an account from which payment is to be made for the transaction, and also comprises at least one product identifier identifying a product purchased in the transaction. The host computer recognizes that the combination of the consumer account identifier and the product identifier qualifies for an incentive offer, and transmits a description of the incentive offer to be offered to the consumer at the point of sale. The host computer receives an indication that the consumer has accepted the offer at the point of sale for the transaction, and records, in a database maintained by the host computer, an indication that the offer is pending for the combination of consumer account identifier and product identifier.

In some embodiments, the transaction is a first transaction and the transaction information is first transaction information, and the method further comprises receiving second transaction information gathered at a point of sale. The second transaction information relates to a second transaction, and comprises the consumer account identifier and the product identifier. The database is searched based on the combination of the consumer account identifier and the product identifier, and it is recognized, based on the search, that the offer is pending for the combination of consumer account identifier the product identifier. In indication is transmitted to the point of sale system that the incentive should be applied to the second transaction.

### BRIEF DESCRIPTION OF THE DRAWINGS

FIG. 1 shows a schematic conceptual diagram of part of a typical purchase transaction, in accordance with an example embodiment of the invention.

FIG. 2 shows a system in accordance with an example embodiment of the invention.

FIG. 3 shows a flowchart of a method in accordance with an example embodiment of the invention.

FIG. 4 shows an example display screen presented on a display of a point of sale (POS) reader device, in accordance with an example embodiment of the invention.

FIG. 5 shows an example display screen presented on display of a POS reader device, in accordance with an example embodiment of the invention.

FIG. 6 shows a flowchart of a method in accordance with an example embodiment of the invention.

FIG. 7 illustrates an instruction to transfer funds from an issuer to a merchant, in accordance with an example embodiment of the invention.

FIG. 8 shows an example display screen presented on a display of a POS reader device, in accordance with an example embodiment of the invention.

FIG. 9 shows an example display screen presented on a display of a POS reader device, in accordance with an example embodiment of the invention.

### DETAILED DESCRIPTION OF THE INVENTION

Embodiments of the invention enable merchants and issuers of credit cards or other payment devices to cooperate in offering incentives to consumers. For example, a consumer who uses a particular credit card at a particular merchant may be offered a coupon, discount, or other kind of incentive to be applied to a future purchase made with the same card at the same merchant. The issuer and merchant may participate in such a system in order to encourage consumers to repeatedly use the issuer's card and to repeatedly patronize the merchant. In accordance with embodiments of the invention, the consumer is given the opportunity to accept or decline the offer. The merchant, issuer, or both, may track the acceptance rate of the offers for marketing purposes, for example to learn which kinds of offers are most often accepted and therefore may be most effective at generating repeat patronage. Also, offers that are declined need not be considered future obligations on the part of the offeror. Conveniently, the offer is presented to the consumer on a display screen of a content-capable point of sale device, and the consumer's indication of acceptance or decline of the offer is read using the point of sale device.

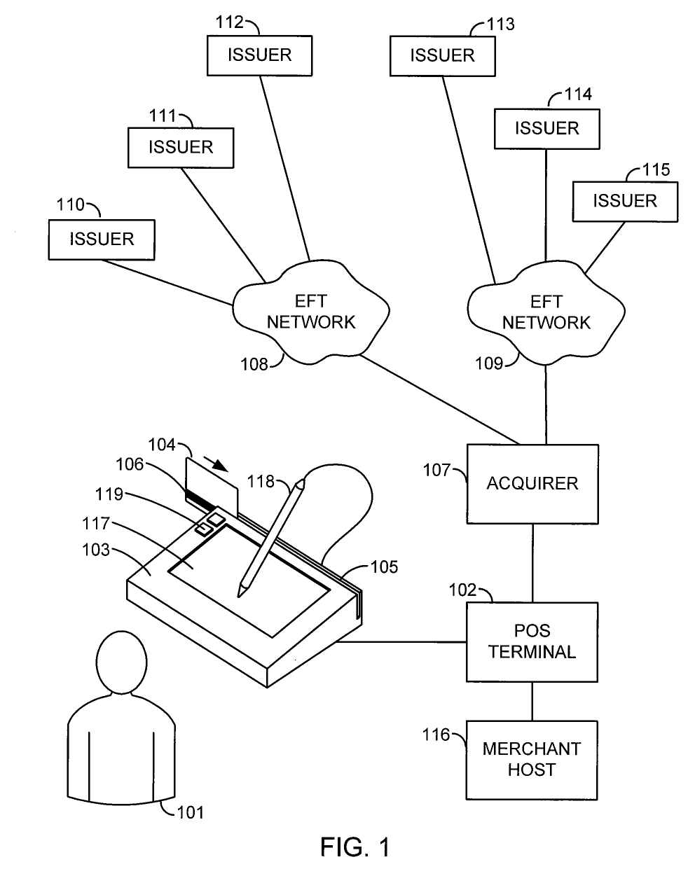

FIG. 1 shows a schematic conceptual diagram of part of a typical purchase transaction, in accordance with an example embodiment of the invention. In this example, a consumer 101 has made a selection of items and arrived at a checkout counter equipped with a point of sale (POS) system. The POS system includes a POS terminal 102 and a POS reader device 103. POS terminal 102 preferably comprises a computer executing a program stored on a computer readable medium, and may perform many functions, including acting as a cash register, cooperating with a scanning system to recognize items being purchased, and other functions. POS terminal 102 may communicate with a merchant host computer 116, for example transmitting a record of what items have been purchased by consumer 101 so that merchant host computer 116 can maintain a store inventory. Once a total price has been determined for the consumer's purchases, consumer 101 presents a payment device 104, which in this example may be a credit or debit card. Consumer 101 or a store clerk “swipes” the card 104 through slot 105 on POS reader device 103, and POS reader 103 automatically reads account information, such as an account number or other account identifier, from magnetic strip 106 on the back of card 104. As part of the transaction, consumer 101 may provide a signature or a personal identification number (PIN) as evidence that consumer 101 is the holder of the account associated with card 104. POS reader device 103 is but one example of a POS reader device that may be used with embodiments of the invention, and many other kinds may be used as well. For example a “contactless” reader device that reads account information from a payment device using radio frequency waves may be used.

In this example, POS terminal 102 compiles a set of transaction information that includes such items as the total amount of the purchase, the date and time of the transaction, a merchant identifier, and the account identifier from card 104. The transaction information may also include other items, such as a merchant classification based on the Standard Industry Classification (SIC) codes developed by the U.S. government for classifying industries. POS terminal 102 sends the compiled transaction information in a standardized format to acquirer 107. For the purposes of this disclosure, an acquirer is an entity that receives purchase transaction information from a merchant and, based on account identifier information, routes the transaction information over an electronic funds transfer network to an issuer of the account being used for payment.

In the example system of FIG. 1, POS reader 103 can read different kinds of cards, issued by many different entities. Example card 104 is a credit card, but reader 103 may also read debit cards, stored value cards, and other kinds of cards. Each credit or debit card is issued by a financial institution, usually a bank. In the case of a credit card, the issuing bank extends credit to the holder of the card. As purchases are made with the card, the amount owed increases. Typically, a statement of charges is mailed to the cardholder monthly, and the cardholder pays the issuing bank to reduce the amount owed. Interest is typically charged on any unpaid balance. In the case of a debit card, the issuing bank maintains a debit account held by the cardholder, for example a checking or savings account. As purchases are made, funds are removed from the debit account to pay for them. In either case, at the time of purchase, the merchant contacts the card issuer (or a processor acting on behalf of the issuer) to verify that there is enough credit available on a credit line or there are enough funds available in a debit account to pay for the purchase.

There are many thousands of institutions that issue cards, and many thousands or millions of merchants that accept cards as payment. In order to simplify the process of transaction approval, many merchants use an acquirer such as acquirer 107 to route transaction information to issuers such as issuers 110-115, and each issuer typically agrees to receive transaction approval requests over one electronic funds transfer (EFT) network, such as EFT networks 108 and 109 shown in FIG. 1. There are roughly dozens of EFT networks in operation, including Visa®, MasterCard®, and others used mainly in credit card transactions, and NYCE®, Star®, and others used mainly in debit transactions. With this configuration, each merchant need only establish a relationship with a single acquirer, and the merchant can accept a wide variety of cards for payments. The acquirer maintains a database that indicates, based on the account number read from each card, to which issuer the transaction information should be routed and over which EFT network.

In accordance with an example embodiment of the invention, POS reader device 103 further comprises a display screen 117. Display screen 117 may be, for example, a color liquid crystal display (LCD) capable of displaying text, images, video, or combinations of these and other kinds of graphical content. Display screen 117 may also be a touch screen display that is sensitive to contact on its face and can be used as an input device. For example, POS reader device 103 may comprise stylus 118 that a customer may use to provide a signature by “writing” directly on display screen 117. A stylus such as stylus 118 may also be used for indicating selections from a menu displayed on display screen 117 as will be explained in more detail later. POS reader device 103 may further comprise buttons 119 or other kinds of input devices.

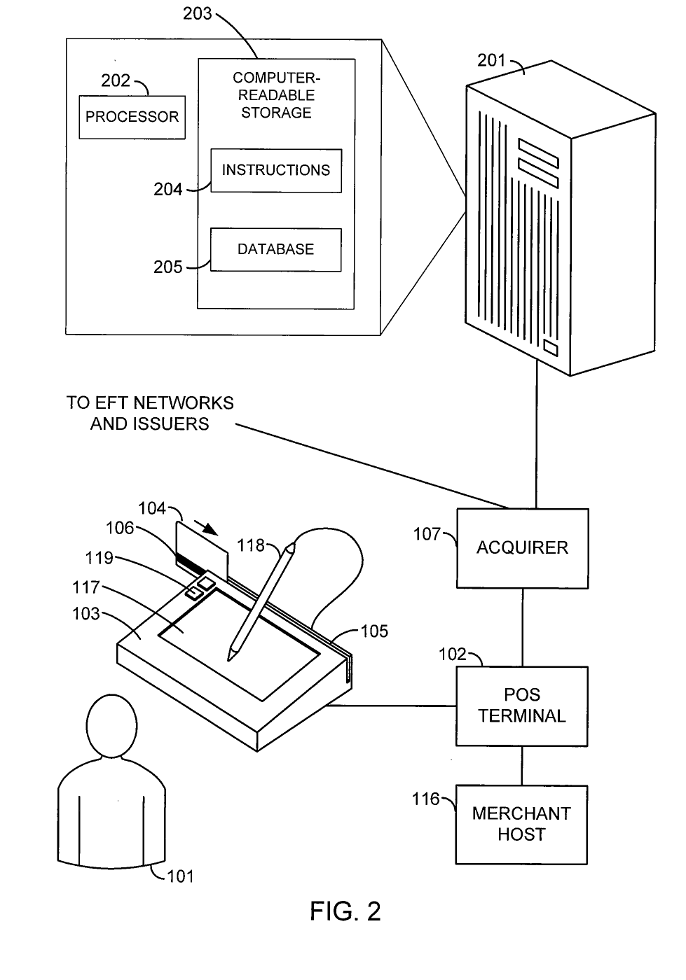

FIG. 2 shows a system in accordance with an example embodiment of the invention. Host computer system 201 conveniently resides at or is in communication with acquirer 107. Host computer system 201 comprises a processor 202, and computer readable storage 203. Computer readable storage 203 holds instructions 204 for carrying out steps of a method in accordance with an embodiment of the invention, and also holds other data such as database 205. While host computer system 201 is shown for ease of explanation as a single computer, one of skill in the art will recognize that host computer 201 may comprise a network of interconnected computers that are co-located or widely dispersed. Similarly, database 205 may comprise multiple files, tables, or other structures, and may reside on a single computer or may be distributed among multiple computers.

Conveniently, as shown in FIG. 2, the invention may be practiced by or in cooperation with acquirer 107, which may provide services to many merchants and cooperate with many issuers. But one of skill in the art will recognize that the invention may be practiced by or in cooperation with other entities having access to the necessary data. For example, an issuer or a merchant may practice embodiments of the invention.

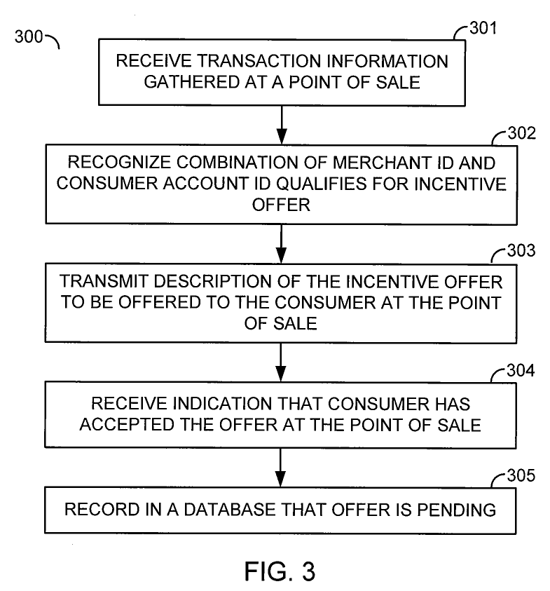

FIG. 3 shows a flowchart of a method 300 in accordance with an example embodiment of the invention. In step 301, transaction information is received. The transaction information is gathered at a point of sale, for example by POS terminal 102. An example transaction information record may be as shown below:

| | |
|---|---|
| Account Number | 1234 5678 9012 3456 |
| Date of the Transaction | 12-MAR-2008 |
| Time of the Transaction | 09:33 |
| Type of Transaction | POS PURCHASE |
| Transaction Amount | $129.37 |
| Merchant Name | GROCERY CLUB |
| Merchant Location | 888 88TH ST |
| | DENVER |
| | CO |
| | 80202 |
| Merchant Classification | 5411 |

Of course, the record shown above is but one simplified example of a transaction record. Many other formats are possible, and a transaction record may contain other information as well. A transaction record need not be human-readable. In the example systems of FIGS. 1 and 2, this kind of transaction record is gathered and sent to acquirer 107 for routing an issuer for transaction approval. Conveniently, the transaction record transmitted for transaction approval also comprises the information needed in order to practice embodiments of the invention—at least a consumer account identifier identifying an account from which payment is to be made for the transaction, and a merchant identifier identifying the merchant. In one example embodiment of the invention, transaction information comprising at least these two items is forwarded to host computer 201. Host computer 201 maintains a record of active incentive arrangements and the incentives to be offered under each arrangement. An example record of incentive arrangements may be as follows:

Active Incentive Arrangements

| Issuer | Merchant | Incentive to be offered |
|---|---|---|
| 123456 | Grocery Club | 1% discount on next purchase |
| 123456 | Fred's Fuel | $1 off next purchase |
| 234567 | Grocery Club | One free item in next purchase |
| . . . | | |

Of course, may other formats are possible for the record of incentive arrangements, and other items of information may be stored in the record. In the table above, a percentage discount, a fixed monetary discount, and a free item are illustrated, but one of skill in the art will recognize that many other kinds of incentive offers are possible within the scope of the claims. At least some kinds of incentive offers may be considered to be electronic coupons.

In step 301 of this example embodiment, host computer 201 receives transaction information comprising at least the consumer account identifier and the merchant identifier. Host computer 201 then searches its table of active incentive arrangements, and in step 302, recognizes that this particular combination of issuer (123456) and merchant (Grocery Club) qualifies for an incentive offer. The issuer of a card or account may often be recognized from the bank identification number (BIN) portion of an account number, usually the first six digits of the account number. Merchants may be identified by name, by a merchant code, or by some other method.

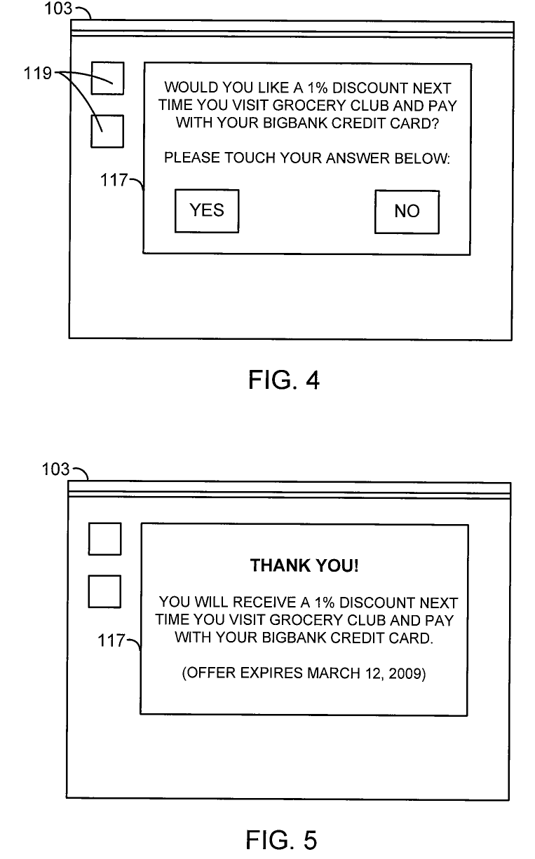

In step 303 of this example embodiment, host computer 201 transmits a description of the incentive offer to be offered to the consumer at the point of sale. Preferably, POS reader device 103 is an intelligent, content-capable, web-enabled device, and the offer is transmitted to POS reader 103 over a link such as the Datawire service operated by First Data Corporation. FIG. 4 shows an example display screen presented on display 117 of POS reader 103 communicating the offer to the consumer. The consumer is given the opportunity to accept or decline the offer, in this example by touching or tapping the “yes” or “no” area on display 117. Many other methods of accepting input from the consumer are possible. For example, the consumer may answer by actuating one of buttons 119, or may accept by waving a contactless payment device near POS reader 103 within a certain time window, or may respond in another way.

In step 304 of this example embodiment, an indication of the user's acceptance of the offer is transmitted to and received by host computer 201.

In step 305, host computer 201 records in database 205 that the offer is pending. For the purposes of this disclosure, pending means that the offer has been presented to and accepted by the consumer, but the incentive award has not yet been provided to the consumer. An example pending offer database may be as follows:

Pending Offers

| Consumer Account | Merchant | Incentive to be offered |
|---|---|---|
| 1234567890123456 | Grocery Club | 1% discount on next purchase |
| 1234567890123456 | Fred's Fuel | $1 off next purchase |
| 2345678901234567 | Grocery Club | One free item in next purchase |
| 2345678901234567 | Fred's Fuel | $1 off next purchase |
| 3456789012345678 | Grocery Club | 1% discount on next purchase |
| . . . | | |

A particular consumer account number may have more than one offer pending with different merchants. The incentive offered at a particular merchant need not be the same for one issuer's account as for another issuer's account.

Assuming the consumer accepts the offer, a message such as is shown in FIG. 5 may be displayed on screen 117 of POS reader device 103. The message informs the consumer that the incentive will be applied when the consumer next visits the merchant and pays with the same account. The message may optionally indicate that the offer has an expiration date. If the incentive is not applied before the expiration date (for example, if the consumer does not visit the merchant before the expiration date, or does not pay using the same account on a subsequent visit), the indication that the offer is pending may be removed from database 205 after the expiration date has passed. Assigning expiration dates to pending offers reduces the amount of storage needed to maintain database 205 over time, and constrains the outstanding financial obligation of the offeror.

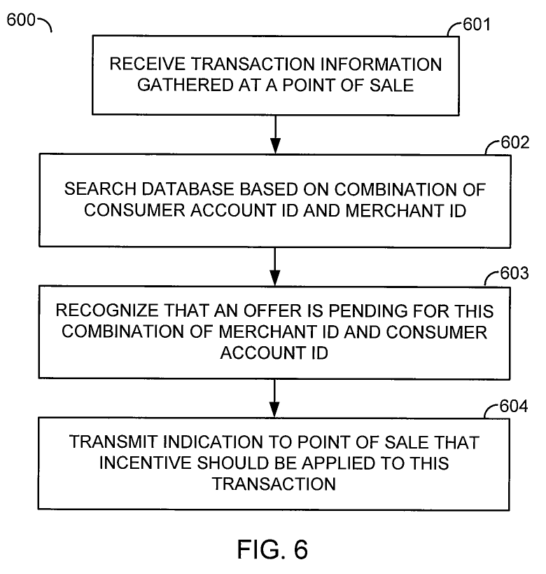

FIG. 6 shows a flowchart of a method 600 for recognizing in a second transaction that an offer is pending from the first transaction, in accordance with an example embodiment of the invention. In step 601, transaction information is received, for example at host computer system 201, for the second transaction. The received transaction information comprises at least the consumer account identifier and the merchant identifier. In step 602, host computer 201 searches its database for offers pending for this particular combination of consumer account identifier and merchant identifier. In step 603, host computer 201 recognizes that a offer is pending, and in step 604, an indication is transmitted to point of sale terminal 102 that the offered incentive should be applied to this second transaction. For the purposes of this disclosure, to apply an incentive means to perform the agreed-upon action. In the above example, this would be to deduct one percent from the total amount due from the consumer for the second transaction.

Once the incentive has been applied, host computer 201 may remove from the database the indication that the offer is pending. Alternatively, the offer may be ongoing, and the host computer 201 may leave the indication in place. In yet another alternative, the same or a different incentive offer may be transmitted to the point of sale to be offered to the consumer during the second transaction. When the consumer “opts into” or accepts the offer, an indication is placed in the database that the new offer is pending, whether the new offer is the same or different than the previous offer.

In another embodiment, host computer 201 maintains a history of incentive offers offered and accepted for the combination of consumer account identifier and merchant identifier. In this way, a particular consumer's acceptance patterns may be tracked, and “milestone” offers may be presented. For example, if a particular consumer repeatedly uses the same consumer account for purchases at the same merchant and receives a one percent discount for ten consecutive purchases, the consumer may be offered a two percent discount on his or her next purchase as a way of rewarding this exceptional loyalty. Of course, to record an offer to a “consumer” means to record an indication that an offer is pending for a particular combination of consumer account identifier and merchant identifier. It is assumed that when a particular consumer account number is used for multiple purchases that it is the same consumer making the purchases each time, or at least someone authorized by the consumer cardholder. Other milestones are possible. For example, a consumer may be offered a particular reward after spending a particular amount at a merchant using a particular credit or debit card. Or a consumer may be offered a milestone offer upon visiting a particular merchant and using a particular credit or debit card a certain number of times in a single month or other time period. One of skill in the art will recognize that many other kinds of milestone offers are possible.

Many variations possible within the scope of the claims. For example, even though the issuer and the merchant cooperate to provide an incentive offer, the offer may be made by only one of the issuer or merchant, or may be made jointly. For the purposes of this disclosure, and offer is made by the entity that funds any value lost or forgone in the application or fulfillment of the offer. For example, if an offer of a one percent discount is made by the merchant, then the merchant simply accepts less for the second transaction than it would have had the offer not been pending.

However, if the offer is made by the issuer but the transaction performed at the merchant, the merchant may be required to at least temporarily forego value it is entitled to. For example, if the issuer offers a one percent discount on the second transaction, and the merchant consequently collects one percent less for a second transaction than it would if the offer were not pending, the merchant has “lost” or foregone that one percent at the behest of the issuer. In some embodiments, the issuer settles this inequity by transferring funds to the merchant to compensate for the lost or foregone value. In this example embodiment, host computer 201 may recognize that this situation has arisen, and send an instruction that funds be transferred from the issuer to a bank account of the affected merchant. The instruction may be an automated clearing house (ACH) instruction file, or a similar instruction. In order for host computer 201 to recognize this situation, it may be necessary that the information about active incentive arrangements stored by host computer 201 include an indication of which entity is making each offer. In some embodiments, the transaction information received by host computer 201 for each transaction may include the transaction amount.

In another example embodiment, an offer may be made jointly by the issuer and the merchant. For example, the issuer and merchant may agree to share equally (or in some unequal proportion) in funding the value lost or foregone by fulfilling the offer to a consumer. In this embodiment, host computer 201 may instruct that some portion of the foregone value be transferred from the issuer to the merchant.

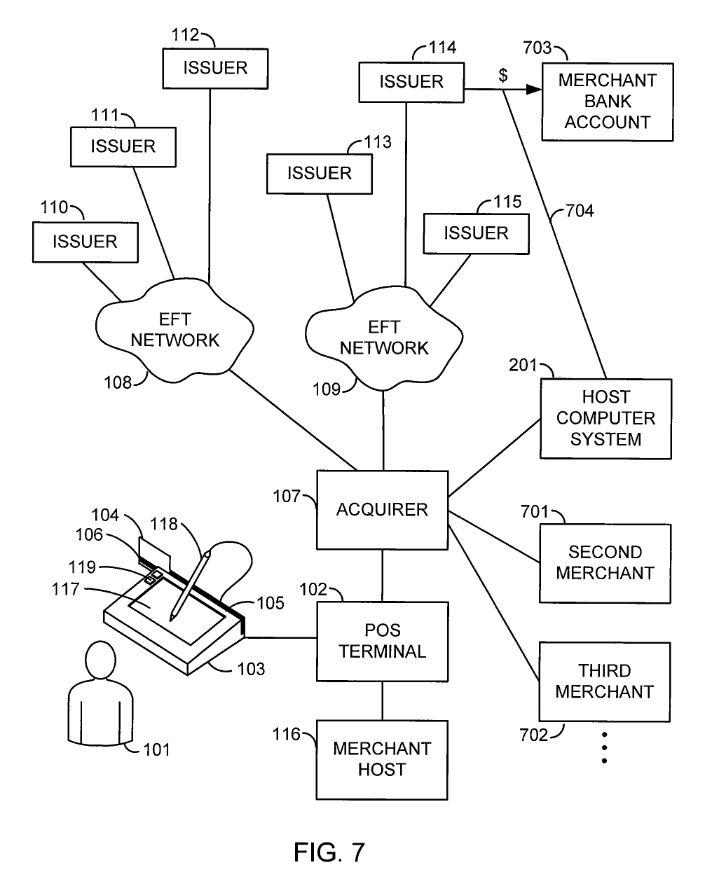

FIG. 7 illustrates the instruction to transfer funds from an issuer to a merchant. In the example illustrated, issuer 114 is the issuer of the consumer account used to make a purchase that qualifies for an incentive offer made by the issuer. Element 704 represents an instruction to transfer funds from issuer 114 to merchant bank account 703. FIG. 6 also illustrates that, in addition to the merchant where POS reader device 103 resides, many different merchants, for example merchants 701 and 702, may utilize the services of acquirer 107. Acquirer 107 may provide incentive management services to multiple combinations of merchants and issuers.

In accordance with another embodiment of the invention, host computer 201 records a history of which incentive offers have been accepted or declined by which consumers. This information may be used by the merchant, issuer, or both for marketing purposes. For example (and purely hypothetically), a merchant may discover that an offer for a fixed monetary discount is accepted more often that an offer of a free item in a future transaction, and that the fixed monetary discount is cheaper to implement. In this case, the merchant may decide not to make offers of free items.

It will be appreciated that coupons offered in accordance with embodiments of the invention have several advantages over prior systems. Electronic coupons or other incentives offered in accordance with embodiments of the invention are narrowly targeted to consumers who are likely to use them. Because the pending incentive offers are tracked by computer, they are not subject to being lost or misplaced by the consumer. Marketing data generated by the patterns of redemption of the offers is gathered quickly and in a form that is easily amenable to analysis.

In accordance with another example embodiment of the invention, a manufacturer of consumer goods may cooperate with a merchant, a card issuer, or both to offer incentives. For example, a consumer who uses a particular credit card to buy a particular product at a participating merchant may be offered a coupon, discount, or other kind of incentive to be applied to a future purchase of the same product made with the same card at the same merchant. Alternatively, the system may not require that the future purchase be made at the same merchant, and may simply offer an incentive to be applied to a future purchase of the same product with the same card.

In one example method of implementing such a system, the transaction information sent to host computer system 201 is expanded to include universal product codes (UPC) or other identifiers that identify the specific products bought during the transaction. An example of this expanded transaction information may be as shown below.

| | |
|---|---|
| Account Number | 1234 5678 9012 3456 |
| Date of the Transaction | 12-MAR-2008 |
| Time of the Transaction | 09:33 |
| Type of Transaction | POS PURCHASE |
| Transaction Amount | $129.37 |
| Merchant Name | GROCERY CLUB |
| Merchant Location | 888 88TH ST |
| | DENVER |
| | CO |
| | 80202 |
| Merchant Classification | 5411 |
| Products purchased | |

| | | |
|---|---|---|
| 036000294152 | 041771566289 | 312843520110 |

In this example, only three products are shown as purchased, but of course the system may record the purchases of any number of products.

A corresponding database, stored for example in database 205, maintains a record of active incentive arrangements involving particular products. An example record of incentive arrangements may be as follows:

Active Incentive Arrangements

| Issuer | Merchant | Product | Incentive to be offered |
|---|---|---|---|
| 123456 | Grocery Club | 041771566289 | $0.50 off on next purchase |
| 123456 | | 312843520110 | $1 off next purchase |
| 234567 | Grocery Club | 041771566289 | Buy one get one free |
| . . . | | | |

In this example, the issuer with BIN 123456 has arranged with Grocery Club and the manufacturer of the item that has UPC code 041771566289 to offer a $0.50 discount on subsequent purchases. The issuer with BIN 234567 has arranged for a different incentive with the same merchant on the same product. And the issuer with BIN 123456 has arranged with the manufacturer of the item that has UPC code 312843520110 to offer a $1.00 discount on future purchases of the product made at any participating merchant. This example uses UPC codes to identify particular products, but one of skill in the art will recognize that other kinds of product identifiers may be used.

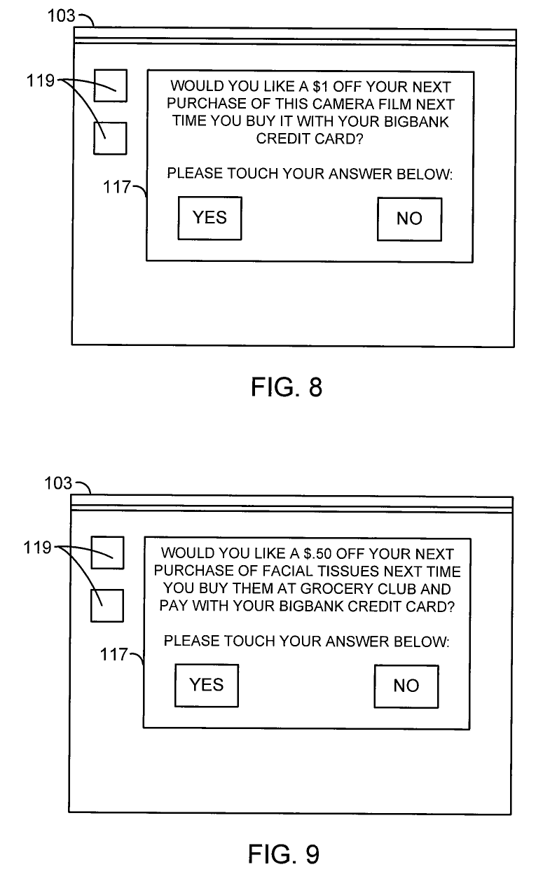

When host computer 201 recognizes that a transaction qualifies for one of the active incentive arrangements, the consumer making the transaction may be offered the chance to “opt in” to the offer. For example, a screen such as is shown in FIG. 8 may be displayed on screen 117 of POS reader device 103. FIG. 9 shows another example screen, offering an incentive that is tied to the product, payment instrument, and also to a particular merchant.

When the consumer indicates that he or she accepts the offer, an indication is transmitted to host computer 201, which records that the offer is pending. In a manner similar to that already described, subsequent transactions are compared with the pending offer database. When it is recognized that a subsequent transaction meets the criteria of a pending offer, an indication is sent to the point of sale that the incentive should be applied to the transaction. As in the previously described embodiments, the pending offer may be removed from the database, the pending offer may be continued, or the consumer may be offered the same or a different incentive offer at the time of the second transaction.

When an incentive offer is based on the purchase of a particular product, the offer may be made by the product manufacturer, by a merchant at which the product is purchased, or by the issuer of the account used to make the purchase, or jointly by combinations of these entities. Various settlements may be performed to reimburse one entity for a value lost or forgone in fulfilling an offer made by another. For example, a manufacturer may be the offeror, and may reimburse the merchant for a discount applied at the time of a purchase. For offers that do not require that a subsequent purchase be made at a particular merchant, the manufacturer, issuer, or both may compensate merchants in some way for providing the expanded transaction information that includes product-level information.

The invention has now been described in detail for the purposes of clarity and understanding. However, those skilled in the art will appreciate that certain changes and modifications may be practiced within the scope of the appended claims.

What is claimed is:

1. A method of providing incentives, the method comprising:
receiving, at a host computer, transaction information gathered at a point of sale system, the transaction information relating to a transaction performed by a consumer at a merchant, wherein the transaction information comprises a consumer account identifier identifying an account from which payment is to be made for the transaction, and also comprises a merchant identifier identifying the merchant;
recognizing, using the host computer, that the combination of the merchant identifier and the consumer account identifier qualifies for an incentive offer;
transmitting, by the host computer, a description of the incentive offer to be offered to the consumer at the point of sale;
receiving, at the host computer, an indication that the consumer has accepted the offer at the point of sale for the transaction; and
recording, in a database maintained by the host computer, an indication that the offer is pending for the combination of consumer account identifier and merchant identifier.

2. The method of claim 1, wherein the incentive is an electronic coupon to be applied to a future transaction conducted with the same combination of consumer account identifier and merchant identifier.

3. The method of claim 1, wherein the transaction is a first transaction and the transaction information is first transaction information, the method further comprising:
receiving second transaction information gathered at a point of sale, the second transaction information relating to a second transaction, wherein the second transaction information comprises the consumer account identifier and the merchant identifier;
searching the database based on the combination of the consumer account identifier and the merchant identifier;
recognizing, based on the search, that the offer is pending for the combination of consumer account identifier and merchant identifier; and
transmitting to the point of sale system an indication that the incentive should be applied to the second transaction.

4. The method of claim 3, further comprising removing from the database the indication that the offer is pending.

5. The method of claim 3, further comprising leaving in the database the indication that the offer is pending.

6. The method of claim 3, further comprising as part of the second transaction transmitting the description of the same incentive offer to be offered to the consumer at the point of sale.

7. The method of claim 3, further comprising as part of the second transaction transmitting a description of a different incentive offer to be offered to the consumer at the point of sale.

8. The method of claim 1, further comprising recording a history of incentive offers offered and accepted for the combination of consumer account identifier and merchant identifier.

9. The method of claim 8, further comprising:
recognizing, based on the history, that a milestone has been reached; and
as part of the second transaction transmitting a description of a milestone incentive offer to be offered to the consumer at the point of sale.

10. The method of claim 1, wherein the offer is made by the merchant.

11. The method of claim 1, wherein the offer is made by an issuer of the consumer account.

12. The method of claim 11, wherein the transaction is a first transaction and the transaction information is first transaction information, the method further comprising:
receiving second transaction information gathered at a point of sale, the second transaction information relating to a second transaction, wherein the second transaction information comprises the consumer account identifier and the merchant identifier;
searching the database based on the combination of the consumer account identifier and the merchant identifier;
recognizing, based on the search, that the offer is outstanding for the combination of consumer account identifier and merchant identifier;
transmitting to the point of sale system an indication that the incentive offer should be applied to the second transaction; and
instructing that funds be transferred from the issuer to the merchant reimbursing the merchant for a value lost or foregone by the merchant in applying the incentive offer.

13. The method of claim 1, wherein the offer is made jointly by the merchant and an issuer of the consumer account.

14. The method of claim 1, wherein the transaction is a first transaction, the consumer is a first consumer, the consumer account identifier is a first consumer account identifier, the account is a first account, the indication is a first indication, and the transaction information is first transaction information, the method further comprising:
receiving second transaction information gathered at the point of sale system, the second transaction information relating to a second transaction performed by a second consumer at the merchant, wherein the second transaction information comprises a second consumer account identifier identifying a second account from which payment is to be made for the second transaction, and also comprises the merchant identifier;
recognizing that the combination of the merchant identifier and the second consumer account identifier qualifies for the incentive offer;
transmitting the description of the incentive offer to be offered to the second consumer at the point of sale;
receiving a second indication that the second consumer has declined the offer;
recording in the same or another database the acceptance of the offer by the first consumer and the decline of the offer by the second consumer.

15. A system for providing incentives, the system comprising:
a host computer comprising a processor and computer-readable storage, the computer-readable storage holding a database and program instructions, the host computer executing the instructions to
receive transaction information gathered at a point of sale system, the transaction information relating to a transaction performed by a consumer at a merchant, wherein the transaction information comprises a consumer account identifier identifying an account from which payment is to be made for the transaction, and also comprises a merchant identifier identifying the merchant;
recognize that the combination of the merchant identifier and the consumer account identifier qualifies for an incentive offer;
transmit a description of the incentive offer to be offered to the consumer at the point of sale;
receive an indication that the consumer has accepted the offer at the point of sale for the transaction; and
record in the database an indication that the offer is pending for the combination of consumer account identifier and merchant identifier.

16. The system of claim 15, wherein the transaction is a first transaction and the transaction information is first transaction information, the host computer further executing the instructions to
receive second transaction information gathered at a point of sale, the second transaction information relating to a second transaction, wherein the second transaction information comprises the consumer account identifier and the merchant identifier;
search the database based on the combination of the consumer account identifier and the merchant identifier;
recognize, based on the search, that the offer is pending for the combination of consumer account identifier and merchant identifier; and
transmit to the point of sale system an indication that the incentive should be applied to the second transaction.

17. The system of claim 16, the host computer further executing the instructions to remove from the database the indication that the offer is pending.

18. The system of claim 16, the host computer further executing the instructions to leave in the database the indication that the offer is pending.

19. The system of claim 16, the host computer further executing the instructions to, as part of the second transaction, transmit the description of the same incentive offer to be offered to the consumer at the point of sale.

20. The system of claim 16, the host computer further executing the instructions to, as part of the second transaction, transmit a description of a different incentive offer to be offered to the consumer at the point of sale.

21. The system of claim 15, the host computer further executing the instructions to record a history of incentive offers offered and accepted for the combination of consumer account identifier and merchant identifier.

22. The system of claim 21, the host computer further executing the instructions to:
recognize, based on the history, that a milestone has been reached; and
as part of the second transaction, transmit a description of a milestone incentive offer to be offered to the consumer at the point of sale.

23. The system of claim 16, the host computer further executing the instructions to instruct that funds be transferred from the issuer to the merchant reimbursing the merchant for a value lost or foregone by the merchant in applying the incentive offer.

24. A method of providing incentives, the method comprising:
receiving, at a host computer, transaction information gathered at a point of sale system, the transaction information relating to a transaction performed by a consumer at a merchant, wherein the transaction information comprises a consumer account identifier identifying an account from which payment is to be made for the transaction, and also comprises a merchant identifier identifying the merchant, and also comprises at least one product identifier identifying a product purchased in the transaction;
recognizing, using the host computer, that the combination of the merchant identifier and the consumer account identifier and the product identifier qualifies for an incentive offer;
transmitting, by the host computer, a description of the incentive offer to be offered to the consumer at the point of sale;
receiving, at the host computer, an indication that the consumer has accepted the offer at the point of sale for the transaction; and
recording, in a database maintained by the host computer, an indication that the offer is pending for the combination of consumer account identifier and merchant identifier and product identifier.

25. The method of claim 24, wherein the transaction is a first transaction and the transaction information is first transaction information, the method further comprising:
receiving second transaction information gathered at a point of sale, the second transaction information relating to a second transaction, wherein the second transaction information comprises the consumer account identifier and the merchant identifier and the product identifier;
searching the database based on the combination of the consumer account identifier and the merchant identifier and the product identifier;
recognizing, based on the search, that the offer is pending for the combination of consumer account identifier and merchant identifier and the product identifier; and
transmitting to the point of sale system an indication that the incentive should be applied to the second transaction.

26. A method of providing incentives, the method comprising:
receiving, at a host computer, transaction information gathered at a point of sale system, the transaction information relating to a transaction performed by a consumer at a merchant, wherein the transaction information comprises a consumer account identifier identifying an account from which payment is to be made for the transaction, and also comprises at least one product identifier identifying a product purchased in the transaction;
recognizing, using the host computer, that the combination of the consumer account identifier and the product identifier qualifies for an incentive offer;
transmitting, by the host computer, a description of the incentive offer to be offered to the consumer at the point of sale;
receiving, at the host computer, an indication that the consumer has accepted the offer at the point of sale for the transaction; and
recording, in a database maintained by the host computer, an indication that the offer is pending for the combination of consumer account identifier and product identifier.

27. The method of claim 26, wherein the transaction is a first transaction and the transaction information is first transaction information, the method further comprising:
receiving second transaction information gathered at a point of sale, the second transaction information relating to a second transaction, wherein the second transaction information comprises the consumer account identifier and the product identifier;
searching the database based on the combination of the consumer account identifier and the product identifier;
recognizing, based on the search, that the offer is pending for the combination of consumer account identifier the product identifier; and
transmitting to the point of sale system an indication that the incentive should be applied to the second transaction.
